(19) United States
(12) Patent Application Publication
(10) Pub. No.: US 2024/0412079 A1
(43) Pub. Date: Dec. 12, 2024

(54) SELECTION OF TRAINING DATA FOR ARTIFICIAL INTELLIGENCE MODELS

(71) Applicant: HONEYWELL INTERNATIONAL INC., Charlotte, NC (US)

(72) Inventors: Viraj Srivastava, Bengaluru (IN); Minal Dani, Bangalore (IN); Chinmaya Kar, Al Jubail (AE)

(21) Appl. No.: 18/208,360

(22) Filed: Jun. 12, 2023

(51) Int. Cl. G06N 5/022

(52) U.S. Cl. CPC G06N 5/022

(57) ABSTRACT

Examples techniques to select training data to train Artificial Intelligence models to monitor industrial processes are described. From historical data relating to an industrial process, a range of values exhibited by operating parameters of the industrial process under normal operation is estimated. One or more steady time windows are identified for the operating parameters. A steady time window of an operating parameter is a duration of time where values of the operating parameter are within the estimated range of values. Based on the identified steady time windows, a composite steady time window is determined. The composite steady time window is a duration of time where a maximum of the identified steady time windows overlap. The data corresponding to the composite steady time window is provided as training data to the AI model.

### BACKGROUND

Industrial processes, such as manufacturing, product handling, production, distribution may involve one or more equipments operating in conjunction with each other to achieve a predefined objective. Examples of operating parameters include operational state, such as an ‘off’ or ‘on’ state of the equipments as well as variable parameters, such as temperature and pressure associated with various components of the equipments, that may be sensed by a corresponding sensor.

An industrial process may generally be carried out in accordance with Standard Operating Procedures (SOP). Operational state of the equipments and their variable parameters may be controlled based on the SOP. To ensure adherence with the SOP, the operating parameters may be monitored as the industrial process progresses to enable corrective action in case any of the operating parameters indicate deviation from the SOP. Often times, data corresponding to the operating parameters being monitored may also be recorded and stored.

Previously recorded data may serve as a basis for monitoring an industrial process in future. For example, operating parameters of an industrial process recorded over a period of time may indicate a range of values for the operating parameter that is expected when the industrial process is progressing as per the SOP. For an on-going industrial process being monitored, when the operating parameters are within the expected range indicated by the previously recorded data, it may be assessed that the equipments are exhibiting their normal behavior and that there is no deviation from the SOP.

Similarly, the previously recorded data may also serve as a basis for training a machine learning model to monitor the industrial process.

Previously recorded data corresponding to the industrial processes is prevalently used as training data to train machine learning models to monitor and control various aspects of the industrial processes.

### SUMMARY

Various embodiments of systems and methods to select training data for an artificial intelligence (AI) model are described herein.

The details of some embodiments of the subject matter described in this specification are set forth in the accompanying drawings and the description below. Other features, aspects, and advantages of the subject matter will become apparent from the description, the drawings, and the claims.

According to an embodiment of the present invention, a method to select training data for an AI model is provided. According to the method, a time series data corresponding to a plurality of operating parameters of an industrial process is obtained. The time series data comprises values of each of the plurality of operating parameters recorded over a time period. For each of the plurality of operating parameters, a range of values is then estimated, wherein the range of values corresponds to at least one mode of operation of the industrial process when the industrial process is exhibiting a normal operation behavior. One or more steady time windows are identified for each of the plurality of operating parameters. A steady time window of an operating parameter is a duration of time within the time period where values of the operating parameter are within the estimated range of values. Further, at least one composite steady time window is determined based on the steady time windows. The composite steady time window is a duration of time within the time period where a steady time window of a maximum of the operating parameters, from amongst the plurality of operating parameters, overlap. In other words, the composite steady time window corresponds to a duration of time in the time period when the maximum operating parameters of the industrial process are within their respective estimated range. The time series data of the plurality of operating parameters, corresponding to the composite steady time window is provided as training data to the AI model to be trained to monitor normal operation behavior of the industrial process.

According to another embodiment of the invention, a training data selection system to select training data for an AI model is provided. The training data selection system comprises a processor and a steady sate range determination module coupled to the processor. For a time series data corresponding to a plurality of operating parameters of an industrial process recorded over a period of time, the steady sate range determination module estimates a range of values corresponding to at least one mode of operation of the industrial process when the industrial process is exhibiting a normal operation behavior. The system further comprises a batch processing module coupled to the processor. The batch processing module divides the time series data into a plurality of batches. Each batch comprises the time series data corresponding to a time frame of predetermined duration in the time period. The batch processing module further processes each batch individually. The batch processing module computes a first score for the respective batches based on a number of operating parameters, from amongst the plurality of operating parameters, having values within the corresponding estimated range of values. The batch processing module also computes a second score for the respective batches based on a number of transient values of plurality of the operating parameters in the corresponding time series data. A transient value of an operating parameter is indicative of a change in values of the operating parameter from the ranges corresponding to one mode of operation of the industrial process to the ranges corresponding to another mode of operation of the industrial process. Finally, the batch processing module assigns a composite score to the respective batches as a weighted sum of the first score and the second score. The system further comprises a training period selection module coupled to the processor. Based on the composite score assigned to each batch by the batch processing module, the training data selection module identifies a set of consecutive batches in the plurality of batches. The training data selection module provides the time series data of the plurality of operating parameters, corresponding to the identified batches, as training data to an AI model to be trained to monitor operation behavior of the industrial process.

According to yet another embodiment of the present invention, a non-transitory computer-readable medium comprising instructions executable by a processing resource to select training data for an artificial intelligence AI model is provided. The instructions, when executed, causes the processing resource to identify, based on historical data corresponding to operation of a system over a time period, an expected range of values for each of a plurality of operating parameters associated with the system. The instructions may also cause the processing resource to extract, from amongst the plurality of operating parameters, a subset of operating parameters that are non-colinear. The instructions further cause the processing resource to identify a duration of time within the time period where each operating parameter in the subset of operating parameters has values within the identified corresponding expected range of values. The instructions also cause the processing resource to select the historical data corresponding to the identified duration of time as data to train an AI model to monitor operation of the system.

### BRIEF DESCRIPTION OF FIGURES

The following detailed description references the drawings, wherein:

FIG. 1 illustrates a network environment for implementing example techniques to select training data to train artificial intelligence models to monitor operation of industrial processes, in accordance with an example implementation of the present subject matter;

FIG. 2 illustrates a training data selection system, in accordance with an example implementation of the present subject matter;

FIG. 3 illustrates the training data selection system, in accordance with another example implementation of the present subject matter;

FIGS. 4a and 4b illustrate graphical representation of output of a probability density function applied on time series data corresponding to two different operating parameters of an industrial process, in accordance with an example implementation of the present subject matter;

FIG. 5 illustrates graphical representation of values of multiple parameters of an industrial process recorded over a time period, according to an example of the present subject matter;

FIG. 6 illustrates a method for selecting training data to train artificial intelligence models to monitor industrial processes, according to an example of the present subject matter;

FIG. 7 illustrates a method for selecting training data to train artificial intelligence models to monitor industrial processes, according to another example implementation of the present subject matter;

FIG. 8 illustrates a method for preprocessing time series data corresponding to a plurality of operating parameters of an industrial process, according to an example of the present subject matter;

FIG. 9 illustrates a method for determining steady state ranges for operating parameters of an industrial process corresponding to one or more mode of operation of an industrial process, according to an example implementation of the present subject matter;

FIG. 10 illustrates a method for identifying a duration of time in the time period for selection of the training data based on steady state time windows of a plurality of operating parameters of an industrial process, according to an example implementation of the present subject matter; and

FIG. 11 illustrates a computing environment for selecting training data for training an artificial intelligence model to monitor an industrial process, according to an example implementation of the present subject matter.

### DETAILED DESCRIPTION

Historical data, comprising values of multiple operating parameters of an industrial process recorded over a period of time is generally available. All or a part of the historical data recorded over the period of time is used for training Artificial Intelligence (AI) models to monitor or predict a normal operating behavior of the industrial process.

Generally, when the historical data is recorded over a significantly long period of time, out of the historical data recorded over the entire period of time, data corresponding to a shorter duration in the given period of time is selected for training the AI models. This duration is typically one where most, if not all, operating parameters of the industrial process exhibited normal operating behavior. Using data pertaining to the selected duration as training data, as opposed to the entire historical data where the operating parameters may have recorded anomalous values, makes the training more accurate and less resource intensive.

The selection of such a duration, hereinafter referred to as training data duration, has conventionally been carried out manually by individuals, such as domain experts or data science experts or a team of both. Selection of the training data duration may involve analysis of a large number of operating parameters. For instance, for an industrial process implemented in a facility, such as a manufacturing plant, the historical data may comprise values of multiple operating parameters pertaining to numerous equipments, such as pumps, values, and sensors involved in the industrial process. Analysis of the historical data for selecting the training data duration in such cases requires the experts to scrutinize time series data comprising values of the multiple operating parameters in conjunction with each other. Accordingly, the conventional manual process of selection of training data duration is generally time-consuming and labor-intensive.

The manual techniques for selection of training data duration may also be prone to human errors. In some cases, such errors may cause training of the AI models to be inaccurate or inefficient. For example, the historical data may include redundant data that may not be identified manually. Inclusion of such redundant data may increase the training time and computing resources involved in the training. Similarly, other errors, such as failure to exclude irrelevant or anomalous data included in the historical data may cause the AI models to be trained incorrectly.

Further, the manual techniques involve application of domain knowledge pertaining to the industrial process by the experts to determine the normal operating behavior of the operating parameters. In some cases, for instance, due to constraints relating to computing resources, the experts may be required to select the training data duration based on a subset of the operating parameters, from amongst all the operating parameters whose data has been recorded. In the other hand, though availability of computing resources may not be a constrain, the experts may select subset of the operating parameters to disregard operating parameters, which in their view, are not relevant for assessment of the normal operating behavior of the industrial process. Thus, the conventional manual process of selection of training data duration is susceptible to subjectivity based on knowledge of the experts. Such techniques may not only achieve inconsistent results in terms of selection of the training data duration, they may also fail to identify the most suitable training data duration.

According to example implementations of the present subject matter, techniques to select training data for AI models to be trained to monitor normal operation of industrial processes are described. The training data corresponds to a training data duration that is automatically selected from a period of time over which operating parameters of an industrial process may have been recorded. The example methods and systems for selection of training data duration eliminate manual intervention involved in selection of training data used to train AI models for monitoring normal operation of the industrial process.

In example implementations, techniques to select training data for an AI model to monitor an industrial process involves automatic analysis of historical data relating to the industrial process. The historical data, as explained above, is a time series data comprising values of a plurality of operating parameters of the industrial process. Based on the historical data pertaining to any of the operating parameters, a typical range of values that the corresponding operating parameters exhibit during normal operation of the industrial process, may be determined.

For any given operating parameter, this typical or expected range of values of is indicative of a steady state for the operating parameter. In other words, when an operating parameter has a value that lies within the expected range, the operating parameter may be understood to be in a steady state or in a state where the operating parameter is not exhibiting anomalous value. Accordingly, a steady state time window, or steady time window for the sake of simplicity, of an operating parameter may be defined as a duration of time within the time period where values of the operating parameter are within the estimated range of values.

One or more steady time windows may be identified for each of the plurality of operating parameters. For instance, during the period of time over which the historical data was recorded, a given operating parameter may have been in a steady state for most of the time, barring instances where the operating parameter recorded atypical values. Likewise, for an equipment that experienced significantly long durations of downtime during the period of time over which the historical data was recorded, a corresponding operating parameter may have been in a steady state for lesser time thereby exhibiting shorter and/or fewer steady time windows.

Based on the steady time windows identified for one or more operating parameters, at least one composite steady time window may be determined. The composite steady time window may be understood as a duration of time within the time period where a steady time window of a maximum number of the operating parameters, from amongst the plurality of operating parameters, overlap. In other words, the composite steady time window corresponds to a duration of time in the time period when a maximum number of operating parameters of the industrial process are in their steady state. Thus, the composite steady time window is identified as the training data duration. The time series data corresponding to the composite steady time window may be provided as training data to the AI model to be trained to monitor normal operation behavior of the industrial process.

The time-consuming and labor-intensive process of selecting training data for an AI model to monitor an industrial process is thus simplified based on the automation of the process of analyzing time series data relating to the multiple operating parameters of the industrial process. Also, as human intervention is minimized, the process of selection of the training data duration is made more reliable, consistent and less resource-intensive.

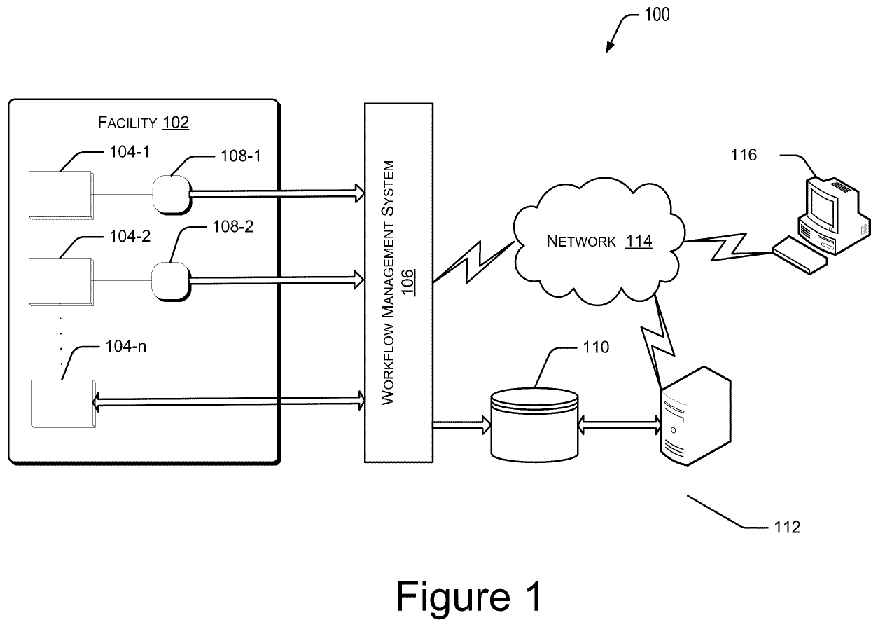

The above techniques are further described with reference to FIG. 1 to FIG. 11. It should be noted that the description and the Figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a network environment for implementing examples techniques to select training data to train Artificial Intelligence models to monitor normal operation of industrial processes, in accordance with an example implementation of the present subject matter.

Industrial processes are carried out in a facility 102, such as oil refineries, chemical plants, paper mills, wherein multiple equipments 104-1, 104-2 . . . , and 104-n, of the facility 102 operate in conjunction with each other to accomplish a predefined task. A workflow management system 106 may be implemented to control the industrial process of the facility 102. The workflow management system 106 controls the equipments 104-1, 104-2 . . . , and 104-n, such that the industrial process is performed in accordance with a SOP to accomplish the predefined task.

The workflow management system 106 may be any computing device, such as a server, a desktop computer, laptop, smartphones, or a tablet. The workflow management system 106 may comprise one or more processors for executing instructions to control and monitor the operating parameters of the equipments. In an example, the processor may be implemented as microprocessors, microcomputers, microcontrollers, digital signal processors, central processing units, state machines, logic circuitries, and/or any devices that manipulate signals based on operational instructions. The workflow management system may comprise a memory for storing the instructions executable by the one or more processor. The instructions may cause the processor to control and monitor the operating parameters of the equipments. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

To control the equipments 104-1, 104-2 . . . , and 104-n, the workflow management system 106 may define values for operating parameters of one or more of the equipments 104-1, 104-2 . . . , and 104-n. Operating parameters of an equipment may be understood as attributes of the equipment that may be controlled or measured. Examples of operating parameters may include operational state, such as an ‘off’ or ‘on’ state of an equipment as well as variable parameters, such as temperature and pressure associated with various components of the equipment, that may be sensed, for example, by a corresponding sensor. Accordingly, one or more sensors 108-1, 108-2 . . . , and 108-n may be connected with the respective equipments 104-1, 104-2 . . . , and 104-n to sense the variable parameters associated with the corresponding equipments 104-1, 104-2 . . . , and 104-n. The workflow management system 106 may use the data from the sensors 108-1, 108-2 . . . , and 108-n, which represent value of corresponding operating parameters to monitor the industrial process. In some cases, the workflow management system 106 may sense an operating parameter of an equipment independent of a sensor. For instance, the workflow management system 106 may directly determine an ‘off’ or ‘on’ state of an equipment coupled to the workflow management system 106. Also, in some situations, one of more operating parameters may be provided to the workflow management system 106 as manual inputs. For instance, an ‘off’ or ‘on’ state of an equipment, such as a manually operable value may be input to the workflow management system 106 by an operator.

In the course of monitoring of the industrial process over a period of time, data comprising the operating parameters of the equipments 104-1, 104-2, . . . , and 104-n involved in the industrial process may be recorded by the workflow management system 106. The workflow management system 106 may record the data as time series data in an example. Time series data may be understood as discrete values of the operating parameters of the equipments 104-1, 104-2, . . . , and 104-n recorded for consecutive instances of time in a given period of time. For instance, values of parameters P1, P2 and P3 of equipment 104-1 recorded at time instance T1 may be different than the values of these parameters recorded at a later time instances T2, T3 . . . . Tn and so on, and may constitute series of data when recorded over a period of time either continuously or intermittently.

The values of the operating parameters of equipments 104-1, 104-2, . . . , and 104-n recorded by the workflow management system 106 may be stored in a database 110. The database 110 may be stored in the memory of the workflow management system 106 in an implementation or may be stored in a memory of any other device, such as an external database server. Implementations where the values of the operating parameters of equipments 104-1, 104-2, . . . , and 104-n recorded by the workflow management system 106 may be stored by devices other than the workflow management system 106 are also possible. Similarly, implementations where the values of the operating parameters of equipments 104-1, 104-2, . . . , and 104-n are recorded by devices other than the workflow management system 106 are also possible.

According to an embodiment of the present invention, the time series data is made available to a training data selection system 112. The training data selection system 112 may be any computing device, such as servers, desktop computers, laptops, smartphones, personal digital assistants (PDAs), and tablets.

In an example, the training data selection system 112 may obtain the time series data from the workflow management system 106 or the database 110 in cases where the database 110 is external to the workflow management system 106. The training data selection system 112, the database 110 and/or the workflow management system 106 may be connected over a network 114 for the purpose of transferring the time series data.

In an example, the network 114 may be a single network or a combination of multiple networks and may use a variety of different communication protocols. The network may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 114 includes various network entities, such as, gateways, routers; however, such details have been omitted for sake of brevity of the present description.

Upon receiving the time series data corresponding to the numerous operating parameters of the industrial process recorded over a time period, the training data selection system 112, selects therefrom a subset of the time series data corresponding to a duration of time within the time period during which the industrial process exhibited a normal operation behavior.

In an example, a training system 116 may be communicatively coupled to the training data selection system 112, for example, over the network 114. The training system 116 may be a computing device such as a server. The training system 116 may comprise the AI model to be trained to monitor and predict normal operation of the industrial process, for example, to generate alerts to enable corrective actions if there is a deviation from the normal operation behavior. In an example, the AI model may be implemented using the machine learning algorithm that learn to predict normal operation behavior of the industrial process. The AI model may include routines, programs, objects, components, data structures, and the like, which perform prediction or implement particular abstract data types.

In accordance with an example of the present subject matter, the training data selection system 112 may provide a subset of the time series data, as training data to the prediction system having the AI model installed thereon. For example, a subset of the time series data corresponding to a duration of time when the industrial process exhibited a normal operation behavior may be provided for the training. Accordingly, the machine learning algorithm of the AI model may be made to learn to predict the normal operation behavior of the industrial process based on the training data.

In an example implementation, the AI model may be installed on the training data selection system 112 itself. Also, in some example implementations, the AI model may be installed on the workflow management system 106. In either case, the AI model may be trained based on the training data indicative of normal operation behavior of the industrial process and once trained, may monitor normal operation of the industrial process.

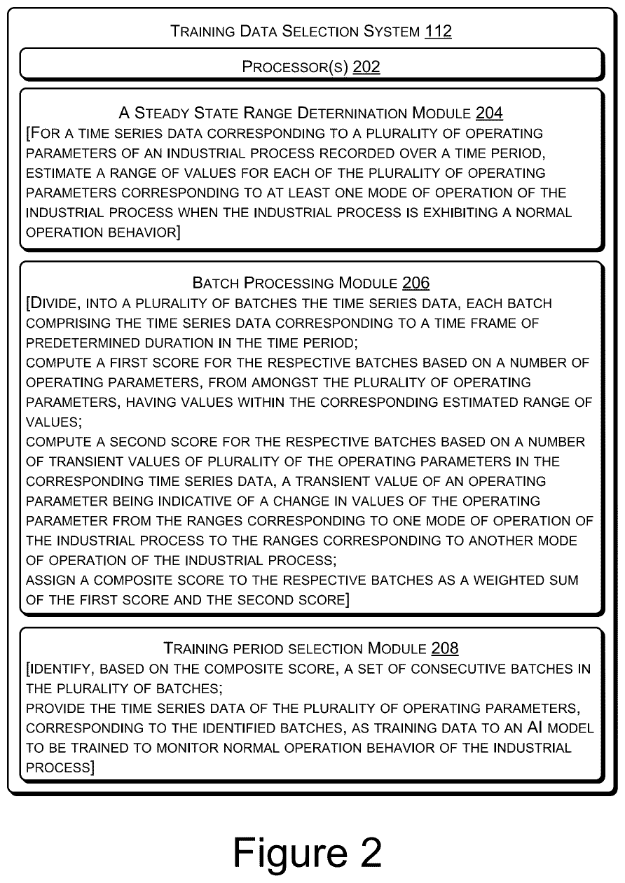

FIG. 2 shows the training data selection system 112, according to an example implementation of the present subject matter. The training data selection system may be one or more computing devices, such as desktop computers, laptops, smartphones, personal digital assistants (PDAs), tablets and servers.

As explained previously, data related to plurality of operating parameters of multiple equipments installed in a facility, such as the facility 102, such as an manufacturing plant where an industrial process is being carried out may be recorded over a period of time. Such data represents a time series data, i.e., values of operating parameters recorded at multiple consecutive time instances over a period of time as the industrial process progresses. The time series data may be provided to the training data selection system 112, for example, through the workflow management system 106 associated with the facility 102 to control and monitor the operating parameters of the equipments 104-1, 104-2 . . . , and 104-n.

In an example, the training data selection system 112 comprises a processor 202 and a steady state range determination module 204, a batch processing module 206 and a training period selection module 208, each coupled to the processor 202 of the training data selection system 202. The module(s) may include routines, programs, objects, components, data structures, and the like, which perform particular tasks when executed by the processor 202 or implement particular abstract data types. In an example, the processor 202 may be implemented as microprocessors, microcomputers, microcontrollers, digital signal processors, central processing units, state machines, logic circuitries, and/or any devices that manipulate signals based on operational instructions.

During the period of time, the equipments 104-1, 104-2 . . . , and 104-n engaged in carrying out the industrial process may be operating in different modes of operation such as a normal operating mode wherein the process is performing intended functions, a shutdown mode or a standby mode. In an example, an equipment of a HVAC system may be operated in various modes, for example, a night-mode, a day-mode or a standby mode. The steady state range determination module 204, for each of the plurality of operating parameters, estimates a range of values corresponding to at least one mode of operation of the industrial process when the industrial process is exhibiting a normal operation behavior. As evident, the normal operating behavior of the industrial process may be understood as a mode of operation of the industrial process in which the industrial process performs the intended function or delivers the expected result. The estimated range of values may correspond to the values of the operating parameters of the equipments carrying out the industrial process as defined in a standard operating procedures for the industrial process.

The batch processing module 206 is operable to divide the time series data into a plurality of batches. The time period over which the time series was recorded may be divided in consecutive time frames of a predetermined duration. Each batch comprises the time series data corresponding to a time frame of the predetermined duration. Each batch is then processed separately by the batch processing module.

The batch processing module 206 is further operable to compute a first score for the each of the batches based on a number of operating parameters, from amongst the plurality of operating parameters, having values within the corresponding estimated range of values. For example, if for a first batch in the plurality of batches, the number of operating parameters having values within the corresponding range of values is greater than in a second batch, the first score of the first batch will be greater than that of the second batch. The batch processing module 206 also computes a second score for the batches. The second score is computed based on a number of transient values of plurality of the operating parameters in the corresponding time series data. A transient value of an operating parameter indicates a change in values of the operating parameter from the ranges corresponding to one mode of operation of the industrial process to the ranges corresponding to another mode of operation of the industrial process. For example, when the process undergoes a transition from a normal operating mode to a standby mode, a substantial change in the values of the operating parameters is experienced. If an operating parameter undergoes such transition multiple times in the time frame corresponding to the respective batch, the operating parameter is considered less stationary. Depending on the stationarity of the operating parameters in the corresponding time frame, a second score is computed. That is, a greater second score is assigned to a batch from others, if more parameters in the corresponding time are stationary than others.

Having computed the values of first and second score for a batch, the batch processing module 206 further, assigns a composite score to the respective batches as a weighted sum of the first score and the second score. In an example implementation, more weightage may be assigned to a first score as compared to the second score, in cases where having values of the operating parameters within the ranges corresponding to normal operation behavior of the industrial process may be considered relevant than the stationarity of the operating parameters.

The training period selection module 208 is operable to identify, based on the composite score, a set of consecutive batches in the plurality of batches. To identify the consecutive set of batches, a threshold score is determined depending on the scores of each batch. The set of consecutive batches is such that each batch in the set of consecutive batch has a composite score greater than the threshold score and a cumulative score of the all the batches in the set of consecutive batches is higher than any other set of consecutive batches in the plurality of batches. The cumulative score of the identified set of consecutive batches represents that, in the time series data corresponding to the set of consecutive batches, most of the operating parameters of the industrial process were substantially stable and the industrial process exhibited a normal operating behavior.

The training period selection module 208 is further operable to provide the time series data of the plurality of operating parameters, corresponding to the identified number of batches, as training data to an AI model to be trained to monitor normal operation behavior of the industrial process. As mentioned with reference to FIG. 1, the AI model may be installed on the training system 116 or the workflow management system 106 or the training data selection system 112. The AI model may be trained using the training data.

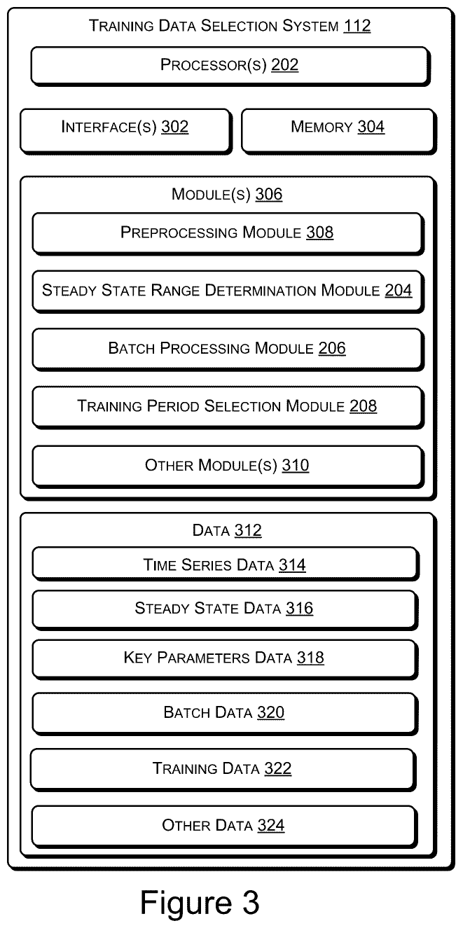

FIG. 3 illustrates the training data selection system 112 according to another example implementation of the present subject matter. In an example, the training data selection system depicted in FIG. 3 may include any computing device, such as servers, desktop computers, laptops, smartphones, personal digital assistants (PDAs), and tablets.

As explained previously, the training data selection system 112 is configured to select training data to train AI models to monitor operation of industrial processes. Industrial process may involve chemical, electrical or mechanical procedures for a predefined purpose, for instance, to manufacture an item or provide air conditioning or generate fire alerts. The industrial process may be carried out in facilities, an example of which has been discussed in reference to FIG. 1. A series of equipments, such as equipments 104-1, 104-2 . . . , and 104-n may be installed in the facility 102 to carry out the industrial process. For example, in case of an HVAC system, equipments such as chillers, boiler, heat exchangers, pumps operate in conjunction with each other to air condition a premises.

In a given industrial process, each equipment may be operated in accordance with predefined operating parameters. As mentioned above, the operating parameters of an equipment may be understood as operational state of the equipment such as ‘on’ or ‘off’ state and other variable parameters such as pressure, temperature, pressure, air flow and humidity in case of an equipment of the HVAC system. Referring to the above example of the HVAC system implemented to air condition a premises, the equipments, i.e., the chillers, boiler, heat exchangers, pumps operate may be operated in accordance with predefined operating parameters as dictated by SOPs, which take into account various factors, such as the temperature to be maintained in the premises, ambient temperature, humidity etc.

Thus, the operating parameters of the equipments may be measured, for example, using sensors coupled to the equipments and controlled as per standard operating procedures SOPs of the industrial process. Any deviation from the SOPs may lead to a failure of the industrial process or may result in an unexpected output. Thus, operating parameters are controlled and monitored. In an example implementation, the workflow management system 106 as depicted in FIG. 1 may monitor and control the operating parameters of the equipments installed in the facility for with compliance of SOPs of the industrial process carried out in the facility. The workflow management system 106 may record the values of operating parameters as received from the sensors or the equipments and behavior as exhibited by the industrial process corresponding these values of operating parameters for a period of time.

The values of operating parameters recorded over a period of time, constitutes the historic data or time series, and may be used to monitor and control the behavior of industrial process in future, as described earlier. In accordance with an example implementation, the training data selection system 112 is provided to select a part of the historic data that may be suitable to train an AI model to monitor the industrial process in future.

In an example implementation, the training data selection system 112 comprises the processor 202. In an example, the processor 202 may be implemented as microprocessors, microcomputers, microcontrollers, digital signal processors, central processing units, state machines, logic circuitries, and/or any devices that manipulate signals based on operational instructions. The training data selection system 112 also comprises interface(s) 302 coupled to the processor 202. The interface(s) 302 may include a variety of software and hardware interfaces that allow interaction of the training data selection system 112 with other communication and computing devices, such as network entities, web servers, and external repositories, and peripheral devices. For example, the interface(s) may couple the training data selection system 112 with the workflow management system 106. The interface(s) 302 may also enable coupling of internal components of the training data selection system 112 with each other.

Further, the training data selection system 112 comprises a memory 304 coupled to the processor 202. The memory 304 may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like. The training data selection system 112 may comprise module(s) 306 and data 312 coupled to the processor 202. In one example, the module(s) 306 and data 312 may reside in the memory 304.

In an example, the data 312 may comprise a time series data 314, steady state data 316, key parameters data 318, batch data 320, training data 322 and other data 324. The module(s) 306 may include routines, programs, objects, components, data structures, and the like, which perform particular tasks or implement particular abstract data types. The module(s) 306 further includes modules that supplement applications on the training data selection system 112, for example, modules of an operating system. The data 312 serves, amongst other things, as a repository for storing data that may be fetched, processed, received, or generated by one or more of the module(s) 306. The module(s) 306 may include a preprocessing module 308, and other module(s) 310 along with the previously explained steady state range determination module 204, batch processing module 206, and training period selection module 208. The other module(s) 310 may include programs or coded instructions that supplement applications and functions, for example, programs in the operating system of the training data selection system 112.

The training data selection system 112 may obtain the recorded time series data from the workflow management system 106 or any other source that may have collected or stored such data, through a database connection over the network. The time series data may be stored in data 312 of the training data selection system 112 as time series data 314.

In an example implementation, the time series data 314 may be preprocessed by the preprocessing module 308 of the training data selection system 112. The time series data generated from physical phenomenon during the progress of industrial process may contain noise or anomalous data. For instance, noise can be added to signals corresponding to operating parameters of an equipment as measured by the sensors. Using techniques, such as Exponentially Weighted Moving Average (EWMA) or Locally Weighted Smoothing (LOESS), noise may be filtered and the filtered signal corresponding to the operating parameter, for example, as measured by the sensor is recreated. A filtered time series data thus obtained may be stored as the time series data 314 in the data 312.

In some example implementations, where the time series data may not need filtering, the training data selection system 112 may not include the preprocessing module 308. Examples of situations where the time series data may not need filtering include, but are not limited to, instances where the preprocessing of data is carried by the source that records and/or stores the data.

In an example, the preprocessing module 308 is further operable to compute a missing data in the time series data. For instance, in the time series data corresponding to operating parameters P1, P2 and P3 obtained at consecutive time instances T1, T2, T3 and T4 in a period of 2 years, data corresponding to time instance T3 of the parameter P2 may be missing. The missing data may be calculated using techniques, such as zero order hold, nearest neighbor imputation and regression. Using nearest neighbor imputation and regression techniques, a missing value of a record is filled with a value obtained from related records, e.g., by averaging the observations in the neighborhood of the missing value.

Further, some of the operating parameters in the plurality of operating parameters may be colinear, that is, parameters which vary in relation to each other. More specifically, the values corresponding to parameters which are colinear vary in proportion to each other in the time series data. For example, the torque of an engine may vary in relation to speed of rotation of the engine. Accordingly, to reduce the data and consequently, the overhead associated with analyzing large volume of the time series data, the preprocessing module 308 may identify a subset of the operating parameters which are non-colinear. In an example, the time series data 314 in data 312 may be tagged or segregated such that the subset of the operating parameters which are non-colinear may be identified and selected for further processing. In another example, the subset of operating parameters may be stored in the key parameters data 318 of the data of the training data selection system 112.

Based on the time series data 314, the steady state range determination module 204 estimates a range of values for each parameter in the subset of operating parameters. The range of values corresponds to at least one or more modes of operation of the industrial process. As the industrial process progresses, the equipments carrying out the industrial process, may be operating in various modes of operation, such as start-up, normal operation, shutdown, maintenance, and stand by. The SOPs of the industrial process define various modes of operation of the industrial process and the corresponding expected behavior of the industrial process in each of the various modes of operation. The SOPs also define values of operating parameters of each equipment for the various modes. When the industrial process exhibits the expected behavior as defined in the SOPs, the industrial process is said to exhibit a normal operational behavior, or simply, a normal behavior.

In real time, as the industrial process operates in a mode of operation, the values of the operating parameters of the equipments may experience a variation from the respective values as defined in the SOPs. However, the values of the parameters remain concentrated around the respective values in a range within which the values reoccur. The steady state range determination module 204 determines such a range of values corresponding to the one or more mode of operation of the industrial process for each operating parameter in the subset of operating parameters.

To estimate the range of values of a parameter, the steady state range determination module 204 replicates the intelligence used by an expert for steady state identification, which includes checking minimum and maximum values of the parameter as recorded in the time series data and deviation from a mean value. The steady state range determination module 204 applies a probability density function on the time series data corresponding to each operating parameter in the subset of operating parameters. The values of a parameter in the time series data contain one or more set of reoccurring values. The output of the probability density function contains a density distribution of the values of the respective parameter in the period of time. The one or more set of reoccurring values has higher density than neighbouring values and are represented as peaks in the output of the probability density function. The set of one or more reoccurring values may then be identified in the output of the probability density function.

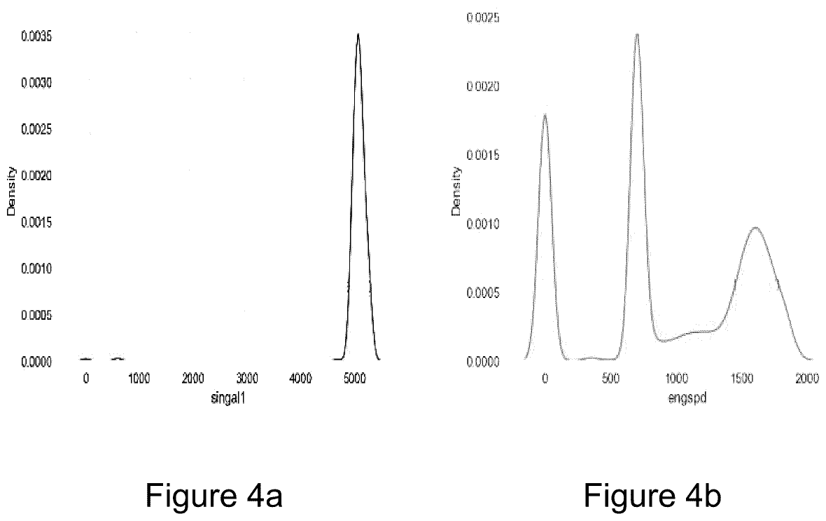

FIGS. 4a and 4b illustrate graphical representation of output of a probability density function applied on time series data corresponding to two different parameters. Each peak represents a mode of operation of the industrial process. In an example, a probability density function, e.g., a kernel density estimator (KDE) may be applied on the filtered time series data corresponding to a parameter, e.g., signal 1 comprising values as obtained by a sensor connected to an equipment. The KDE considers the values corresponding to the parameter as a one-dimensional array and calculates all local maxima by comparison of neighbouring values. The local maxima are represented as peaks in the output of the KDE. Once the values corresponding to the peaks are identified, a steady state range may be calculated corresponding to each peak or mode of operation of the industrial process. In an example, to calculate the steady state range corresponding to a peak, a lower and an upper value of the respective parameter corresponding a predetermined percentage of the density at the peak are identified in the neighbourhood of the peak. These values represent a steady state range for the corresponding peak or mode of operation. The steady state ranges corresponding to one or more mode of operation for each parameter in the subset of operating parameters may be stored in the steady state range data 316 in data 312.

Referring to FIG. 4a, a single peak with a density of 0.0035 is identified in the output of the probability density function. The single peak may represent as one normal mode of operation of the industrial process where the output of the process is as defined in the SOPs. The corresponding value of parameter, ‘signal 1’ is identified as 5100 in said normal mode. That is, the parameter, ‘signal 1’ is most likely to have a value of 5100. If the predetermined percentage of the density is 25% for example, the range of values for the peak is identified as 4800 to 5400. Accordingly, when values of parameter signal 1 lies within 4800 to 5400, the parameter may be said to be in the expected range of values.

Similarly, FIG. 4b represents the output of a probability density function applied on the time series data corresponding to a parameter, namely, engine speed, that represents speed of an engine of an equipment. Three peaks in the output are identified in the example depicted in FIG. 4b. First peak corresponds to a value of engine speed of 0, a second peak corresponds to a value of engine speed of 700 and a third peak corresponding to an engine speed of approximately 1625. The operating mode corresponding to the peak value at speed 0 may be a state when the engine is off, while operating mode corresponding to the peak value at speed 700 may be a state when the engine is idle. The operating mode corresponding to the engine speed of approximately 1625 may be state when the engine is delivering a rated torque output. Accordingly, the steady state range of values corresponding to the modes where the engine is off, idle and delivering a rated torque output, may be approximately 1 to 50; 600 to 800; and 1450 to 1800, respectively.

Once the steady state ranges corresponding to each mode of operation for each parameter are identified, the batch processing module 206 may divide the time series data into a plurality of batches. Each batch comprises the time series data corresponding to a time frame of a predetermined duration in the time period. In an example, the time frame of a predetermined duration and the time series data corresponding to each batch may be stored in the batch data 320 in data 312. For instance, the time series data recorded over a period of two years may be divided in batches of data corresponding to a duration of one month. The total number of batches in this case is 24, i.e., B1, B2, B3 . . . . B24. The predetermined time frame may be stored in the batch data. The batch processing module 206 processes each batch separately, in an example implementation. The batch processing module 206 may optionally scale the values of parameters in the subset of parameters according to a predetermined criteria. The steady state ranges for a parameter, may be considered a limit for scaling the values of the respective parameter in the time series data.

In an example, the batch processing module 206 identifies a number of parameters for each batch, having values within the corresponding estimated range of values. A first score may be computed for each batch based on the corresponding number of parameters as identified by the batch processing module to be within the expected range. The first score of the batch with greater number of parameters having values within the corresponding steady state range than another batch is greater than the first score of the other batch. For example, for batch B1 and B5, the number of parameters having values within the corresponding steady state range are 5 and 3 respectively. In this case, Batch B1, is assigned a greater first score, e.g., 85, than batch B5 which may be assigned a first score of 70.

The batch processing module 206 may further identify a number of transient values of the operating parameters in the batches. A transient value of an operating parameter is indicative of a change in values of the operating parameter from the ranges corresponding to one mode of operation of the industrial process to the ranges corresponding to another mode of operation of the industrial process. For instance, if the industrial process undergoes a transition from a mode of operation to another mode multiple times in the time frame corresponding to a batch, some or all of the parameters in the subset of parameters undergo a substantial change. A batch with higher number of parameters that undergo such changes is considered less stationary as compared to other batches with fewer parameters that exhibit such changes. As a corollary, a batch with higher number instances of transition from a mode to another is considered less stationary that a batch with instances of transition. A second score of the respective batches is assigned based on a number of transient values of the operating parameters in the time series data corresponding to the batches. A greater second score is assigned to a batch if more parameters in the corresponding time from are stationary than others.

The batch processing module 206 is further operable to assign a composite score to the respective batch as a weighted sum of the first score and the second score. In an example, for industrial processes where having values of the operating parameters within the steady state ranges may be considered more relevant than the stationarity of the operating parameters, more weight may be assigned to the first score as compared to the second score. Thus, to compute the composite score, the batch processing module 206 may be configured to assign different weights to the first score and the second score depending on an industrial process under consideration.

Having computed the composite score for each batch, the training period selection module 208, identifies a set of consecutive batches with highest composite score in the plurality of batches.

In an example implementation, based on a selection criteria that may be configured in the training period selection module 208, a range of high scores are defined depending on the scores of each batch. The set of batches comprises batches having composite scores within the range of high scores such that composite scores of all the batches in the set is higher than any other set of consecutive batches in the plurality of batches. For example, given composite scores for 11 batches as—B1:35, B2:45, B3:100, B4:95, B5:99, B6:75, B7:95, B8:99, B9:45, B10:75, B10:35, B11:0, based on a selection criteria of score 90, the range of high scores may be 90 to 100. Accordingly, the consecutive set of batches that may be identified as comprises batches {B3; B4; B5}. As a second preference, the consecutive set of batches may comprise batches {B7; B8}.

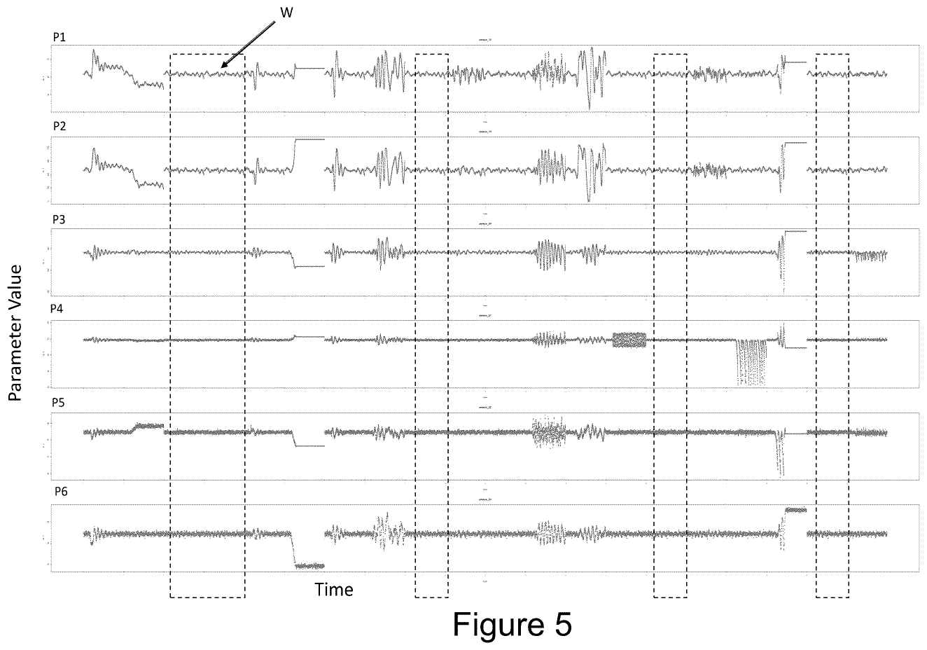

FIG. 5 illustrates graphical representation of values of multiple parameters of an industrial process recorded over a time period, in accordance with an example. In the illustrated example, the time period is a period of 19 weeks and the time series data comprising values of parameters P1-P6 recorded over the period of 19 weeks is divided into batches B1-B19, each comprising values of parameters corresponding to a time frame of one week in the time period of 19 weeks. The values of parameters corresponding to contiguous set of batches {B4; B5} as represented through a window ‘W’ in FIG. 5 are found substantially stationary and stable. Thus, the data corresponding to the batches {B4; B5} may be selected as training data.

The time series data of the plurality of operating parameters, corresponding to the identified batches is selected as training data which may be stored in the training data 322 of the data 312 of the training data selection system 112. The training period selection module 208 provide the training data to an AI model to be trained to monitor normal operation behavior of the industrial process.

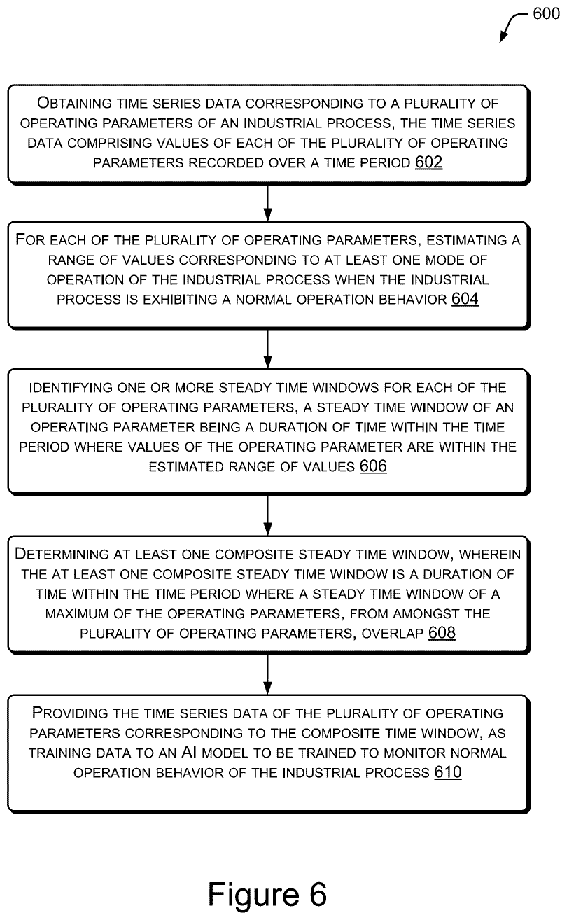

FIG. 6 illustrates a method 600 for selecting training data to train Artificial Intelligence models to monitor industrial processes, according to an example. Although the method 600 and may be implemented in a variety of computer-based systems, for the ease of explanation, the present description of the example method 600 to select the training data is provided in reference to the above-described training data selection system 112.

The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine readable instructions, or combination thereof.

It may be understood that blocks of the method 600 may be performed by programmed computing devices. The blocks of the method 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 6, at block 602, time series data corresponding to a plurality of operating parameters of an industrial process is obtained. The time series data comprises values of each of the plurality of operating parameters recorded over a time period. As explained previously, operating parameters correspond to one or more equipments, such as equipments 104-1, 104-2 . . . , and 104-n involved in the industrial process and have a value that may be sensed or measured.

At block 604, a range of values corresponding to at least one mode of operation of the industrial process when the industrial process is exhibiting a normal operation behavior is estimated for each of the operating parameters. For instance, in an industrial process requiring an equipment of a HVAC system to operate in two modes, for example, a night-mode and a day-mode, the operating parameters of the equipment may exhibit a first range of values in the night-mode that may be different from a second range of value exhibited in the day-mode. In an example, the range of values corresponding to each of the modes of the industrial process is estimated based on identification of the set of reoccurring values in the time series data as previously explained.

At block 606, one or more steady time windows for each of the plurality of operating parameters is identified. As explained previously, the steady time window of an operating parameter is a time window within the time period where the operating parameter has values that are within the estimated range of values. Based on the one or more steady time windows for each of the plurality of operating parameters identified at block 606, at block 608, at least one composite steady time window, wherein a steady time window of a maximum of the operating parameters overlap, is determined. In an example, the at least one composite steady time window comprises a longest duration of time within the time period where the steady time window of the maximum of the operating parameters, from amongst the plurality of operating parameters, overlap.

The time series data of the plurality of operating parameters, corresponding to the composite steady time window, is provided as training data to an AI model to be trained to monitor normal operation behavior of the industrial process at block 506. Since the composite steady time window corresponds to a duration of time in the time period when a maximum number of operating parameters of the industrial process are in their steady state, data recorded during the composite steady time window is most suitable to train the AI model to monitor normal operation behavior of the industrial process.

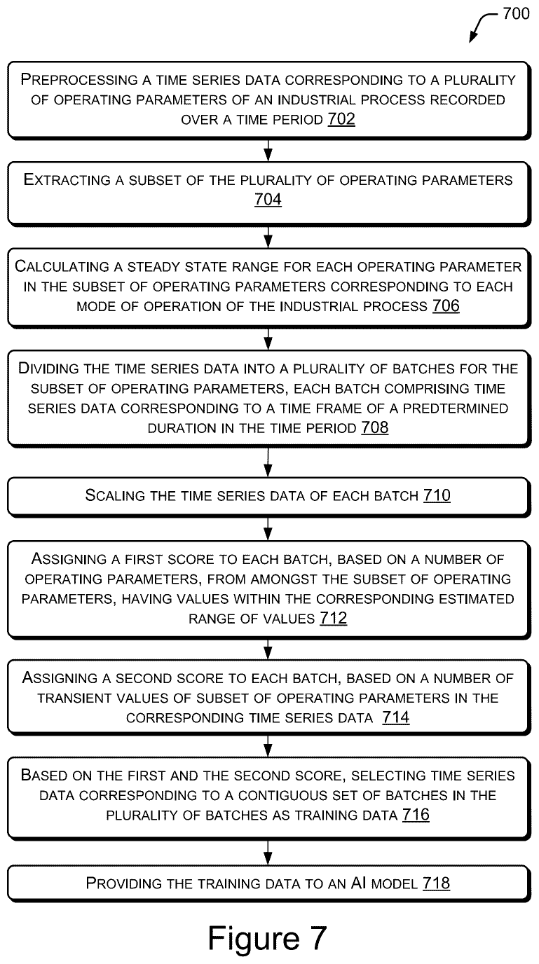

FIG. 7 illustrates a method 700 for selecting training data to train AI models to monitor industrial processes, according to another example of the present subject matter. Although, the method 700 may be implemented in a variety of computer-based systems, as is the case with method 600, for the ease of explanation, the method 700 is described in reference to above-described training data selection system 112.

The method 700 may be implemented by a processor(s) or computing device(s) through any suitable hardware, non-transitory machine-readable instructions, or combination thereof. It may be understood that blocks of the method 700 may be performed by programmed computing devices such as the training data selection system 112. The blocks of the method 700 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

The training data to train AI models to monitor normal operation of an industrial processes may be selected by the training data selection system 112 from a time series data recorded over a time period by the workflow management system 106 connected to the facility carrying out the industrial process as discussed above.

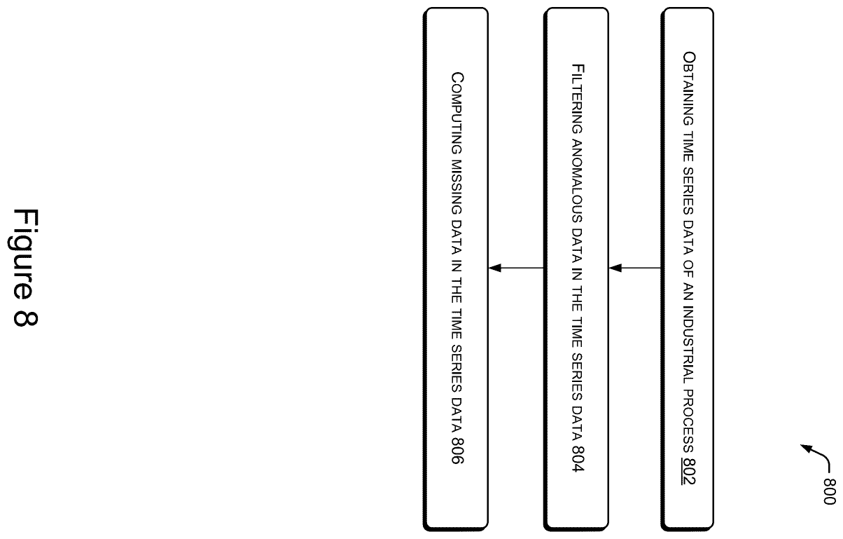

Referring to FIG. 7, at block 702, the training data selection system 112 preprocesses the time series data corresponding to a plurality of operating parameters of the industrial process recorded over a time period. In an example, the preprocessing module 308 of the training data selection system 112 preprocesses the time series data. The time series data may contain anomalies, such as noise or missing values. The preprocessing module 308 removes the anomalies from the time series data and computes the missing values as elaborated in reference to FIG. 3 and, subsequently, in reference to FIG. 8.

Once the time series data is preprocessed, the method proceeds to block 704. At block 704, the preprocessing module 308, extracts a subset of operating parameters. The subset of operating parameters contains the operating parameters which are non-colinear, that is, the parameters which do not vary in relation to each other. Parameters which are colinear vary in sync with each other as explained above.

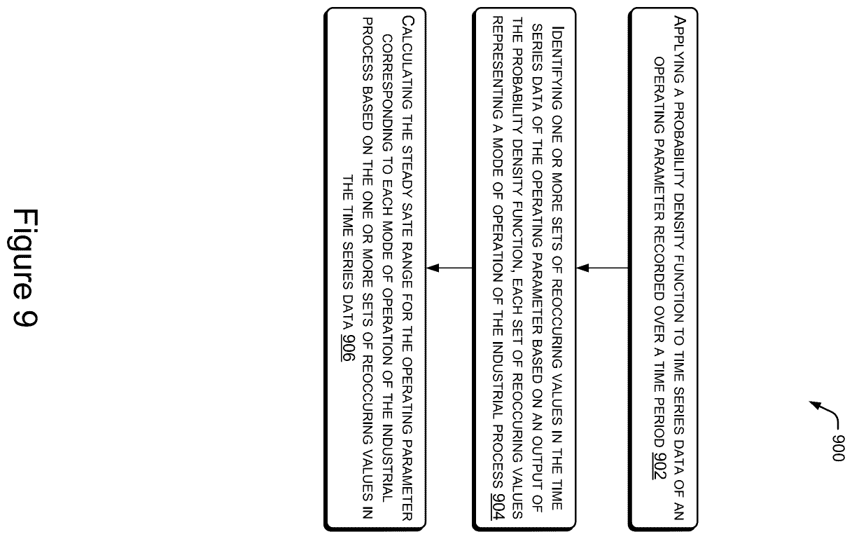

At block 706, a steady state range is calculated for each parameters in the subset of parameters based on the time series data. The steady state corresponds to at least one mode of operation of the industrial process when the industrial process is exhibiting a normal operation behavior. As described earlier, the values of an operating parameter may not be exactly in line with the corresponding value as specified in SOPs for a normal operation behavior of the industrial process in the corresponding mode. Also, as industrial process may be operating in various modes of operation, such as normal operation mode, standby mode, shutdown mode, the steady state ranges may be different for every mode of operation. Steady state range corresponding to a mode of operation represents values for the respective parameter which are considered typical of the normal behavior of industrial process in corresponding operating mode. The steady state ranges may be calculated by the steady state range determination module 204 of the training data selection system 112 as described in reference to FIG. 3 above, and in reference to FIG. 9 subsequently.

At block 708, the time series data corresponding to the subset of parameter is divided into plurality of batches. In an example, the batch processing module 206 of the training data selection system 112 may divide the time series data into batches. Each batch comprises time series data corresponding to a time frame of predetermined duration in the period of time. For example, if the time period during which the time series was recorded is 1 year, the time series data may be divided into 12 batches, each comprising time series data corresponding to a duration of one month.

At block 710, the time series data corresponding to each batch is scaled, for example, by the batch processing module 206. In an example, min-max scaling is used to scale the time series data corresponding to each batch to enable visualization of all the parameters in a confined space. The scaling is performed considering the corresponding steady state range as limit for scaling. The steady state range comprising a lower and an upper value, as derived using a probability density function for the corresponding parameter, may be used as minimum and maximum values while scaling the parameter using min-max scaling.

At block 712, a first score is assigned to each batch based on a number of operating parameters from amongst the subset of operating parameters having values within the corresponding estimated range of values. Further at block 714, a second score is assigned to each batch based on a number of transient values of the operating parameters from amongst the subset of operating parameters. The transient value for a parameter represents a number of times values of the parameter undergo a change from a steady state range corresponding to one mode of operation to a steady state range corresponding to another mode of operation.

At block 716, based on the first score and the second score, the time series data corresponding to a contiguous set of batches in the plurality of batches is selected as training data. For example, a weighted sum of the first score and the second score of the respective batch, i.e., the composite score, can be calculated. The contiguous set may be identified as a set of batches, wherein each batch has a composite score greater than a predefined threshold and a sum of composite scores of each batch is greater than any other contiguous set of batches. Finally, at block 718, the training data may be provided to the AI model for monitoring the normal operation behavior of an industrial process.

FIG. 8 illustrates a method 800 for preprocessing time series data corresponding to a plurality of operating parameters of an industrial process, according to an example. In an embodiment, the method 800 for preprocessing time series data, comprises steps that may, in any sequence or combination, be carried out to accomplish the function as described in block 702 of the above-described method 700 for selecting training data to train Artificial Intelligence models to monitor industrial processes.

Although the method 800 for preprocessing time series data may be performed by any computing system, for the ease of explanation, the method 800 is herein explained in reference to the training data selection system 112. Accordingly, in the examples provided in reference to method 800, the preprocessing module of the training data selection system 112 may perform the steps of the method 800.

Referring to FIG. 8, at block 802, time series data corresponding to the plurality of operating parameters of an industrial process is obtained. For example, the time series data may be obtained from the database 112 through a database connection over the network 114.

At block 804, the preprocessing module may filter anomalous data that may be included in the time series data. Anomalous data may be considered as data that may not be relevant for assessment of a normal operating behavior of the industrial process. Such anomalous data may include redundant data present in the time series data. Such anomalous data may also include noise can may be added to signals corresponding to operating parameters of an equipment involved in the industrial process. In an example, the preprocessing module 308 may filter the noise from the time series data using techniques, such as EWMA or LOESS. The EWMA is a statistical measure used to describe a time series data. In EWMA, a weighted average of the time series data, i.e., weighted average of data obtained at different consecutive time instances is calculated, wherein a less weight is assigned to the data obtained at previous time instance than the data obtained at a later time instance. The LOESS is a nonparametric method for smoothing a series of data.

At block 806, the preprocessing module 308 may compute data that may be missing in the time series data. The time series data corresponding to an operating parameter may be incomplete due to various reasons. For example, a value of the operating parameter may not have been recorded at a time instance t5 in the consequent time instances, t0, t1, t2, t3 . . . tN that the time series data pertains to. As discussed previously, the missing data may be computed using techniques, such as zero order hold, nearest neighbor imputation and regression that enable the value the data missing in the time series data to be computed based on values recorded proximate in time to the missing value in the time series data. For example, the values of the operating parameter recorded at time instances t2, t3 and t4 and/or time instances t6, 173 and t8 may be used to compute the value missed at a time instance t5.

FIG. 9 illustrates a method 900 for determining steady state ranges for operating parameters of an industrial process corresponding to one or more mode of operation of the industrial process, according to an example. In an embodiment, the method 900 comprises steps that may, in any sequence or combination, be carried out to accomplish the function as described in block 706 of the above-described method 700 for selecting training data to train Artificial Intelligence models to monitor industrial processes.

Although the method 900 for determining steady state ranges for the operating parameters of the industrial process may be performed by any computing system, for the ease of explanation, the method 900 is herein explained in reference to the above-described training data selection system 112. Accordingly, in the examples provided in reference to method 900, the steady state range determination module of the training data selection system 112 may perform the steps of the method 900. Also, while the steady state ranges for the operating parameters of the industrial process may be determined for each of the plurality of operating parameters of the industrial process, the method 900 is herein explained in reference to one of the operating parameter. The steps of the method 900 may be performed for each of the plurality of operating parameters to determine their respective steady state ranges corresponding to one or more modes of operation of the industrial process.

At block 902, the steady state range determination module may apply a probability density function to time series data of an operating parameter of an industrial process recorded over a time period. At block 904, based on an output of the probability density function applied at block 902, one or more sets of recurring values in the time series data of the operating parameter is identified. As discussed previously, each set of recurring values is represented as a peak in the output of the probability density function and is indicative of a mode of operation of the operating parameter.

A steady state range may be determined corresponding to each mode of operation of the industrial process for the operating parameter, at block 906. For example, the steady state range determination module 204 may determine the steady state range for each operating parameter in each mode based on the one or more sets of recurring values in the time series data of the operating parameter identified at block 904.

For the operating parameter, the steady state range is the typical or expected range of values that the operating parameter exhibits when the industrial process is progressing as expected in the corresponding mode. Based on the steady state range of the operating parameter, a duration of time within the time period where values of the operating parameter are in the steady range, known as steady state time window, is determined. In a similar manner, a steady state time window may be identified for each of the plurality of operating parameters of the industrial process and a duration of time where the steady state time window of a maximum number of the operating parameter coincide may be identified for selection of the training data.

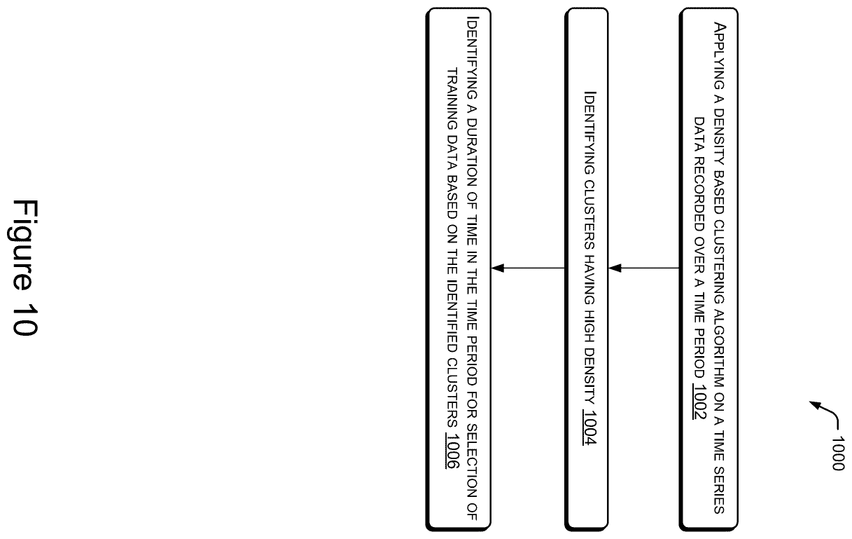

Reference is now made to FIG. 10 that describes method 1000 for identifying a duration of time in the time period for selection of the training data based on steady state time windows of a plurality of operating parameters of an industrial process.

At block 1002, a density based clustering algorithm is applied on the time series data and an output of the clustering algorithm contains one or more clusters. The clusters may be formed by grouping together values of the plurality of parameters that are closely packed together when the time series data is represented in a multidimensional space. In an example, the density based clustering algorithm may use two variables, i.e., a minimum number of points to be clustered together for a region in a multidimensional space to be considered as a cluster and a distance measure that may be used to locate the points in the neighborhood of any point. Each cluster represents that the industrial process exhibits similar behavior during the period represented through the respective cluster and is assigned a density score.

At step 1004, clusters having density higher than a predefined density score are identified. The score of each batch may also be mapped to the clusters identified.

At step 1006, number of batches corresponding to a duration of time of the identified high-density clusters represents the contiguous set of batches having a highest cumulative score and where each batch in the contiguous set of batches has a composite score greater than a score defined by a predefined selection criteria. The duration of time represents the composite time window, where the steady state time window of a maximum number of the operating parameter coincide.

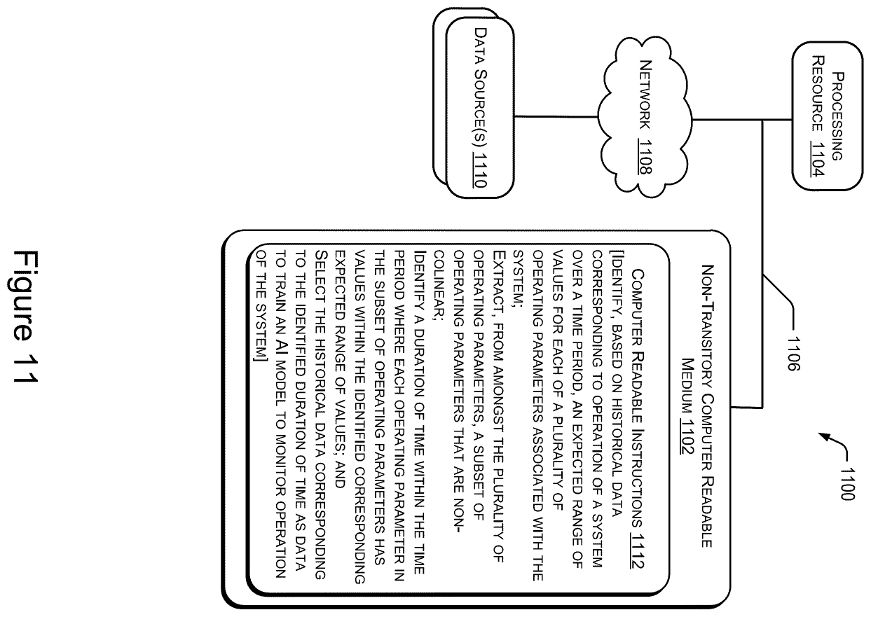

FIG. 11 illustrates a computing environment 1100 selecting training data for the purposes of training an AI model to monitor an industrial process, according to an example. In an example implementation, the computing environment 1100 may comprise a computing device, such as the above-described training data selection system 112. The computing environment 1100 includes a processing resource 1104 communicatively coupled to the non-transitory computer-readable medium 1102 through a communication link 1106. In an example, the processor resource 1104 may be a processor of the computing device, such as the processor 300 of the training data selection system 112, that fetches and executes computer-readable instructions from the non-transitory computer-readable medium 1102.

The non-transitory computer-readable medium 1102 can be, for example, an internal memory device or an external memory device. In an example implementation, the communication link 1106 may be a direct communication link, such as any memory read/write interface. In another example implementation, the communication link 1106 may be an indirect communication link, such as a network interface. In such a case, the processing resource 1104 can access the non-transitory computer-readable medium 1102 through a network 1108. The network 1108 may be a single network or a combination of multiple networks and may use a variety of different communication protocols.

The processing resource 1104 and the non-transitory computer-readable medium 1102 may also be communicatively coupled to data sources 1110. The data source(s) 1110 may be used to store historical data corresponding to operation of a system over a time period, in an example. The system may comprise one or more equipments involved in the industrial process that is to be monitored. The system may be a part of a facility or a plant where the industrial process is carried out, for example, in accordance with SOPs.

In an example implementation, the non-transitory computer-readable medium 1102 comprises executable instructions 1112 for identifying, from amongst the historical data corresponding to operation of the system over the time period, a portion of the historical data that may be used to train AI models to monitor future operations of the system and in turn monitor the industrial process.

In an example, the instructions 1112 cause the processing resource 1104 to filter anomalous data from the historical data and to compute the missing data. The anomalous data may include noise or irrelevant data as previously explained.

In an example, the instructions 1112 cause the processing resource 1104 to identify, based on historical data, an expected range of values for each of a plurality of operating parameters associated with the system. As mentioned before, the expected range of values for each of the plurality of operating parameters corresponds to at least one mode of operation of the system. Further, operating parameters associated with the system are operational state and other measurable parameters of the system. For example, for a system, such as a fluid control system comprising a fluid tank and a control valve operable to discharge fluid from the tank, the operating parameters may be the temperature, pressure, and flow rate of the fluid across the value; and temperature, pressure, and level of the fluid in the fluid tank. When the fluid control system functions as expected, for example, as defined by the SOP, the flow rate of the fluid across the valve has a predetermined value. Similarly, when the value works as expected to discharge fluid out to the tank at the expected flow rate, the level of the fluid in the fluid tank decreases in a predetermined rate. Though there may be some variation in the flow rate and rate of change of fluid level from one cycle of operation of the fluid control system to another, the values of these operating parameters remain confined within a range. Thus, historical data comprising data captured when the system is operating as expected, reveals the expected range of values that the operating parameters of the system attain during the normal operation.

In an example, the instructions 1112 may further cause the processing resource 1104 to scale values of each of the plurality of operating parameters in the historical data based on the identified expected range of values of the respective parameter. The steady state ranges for a parameter, may be considered a limit for scaling the values of the respective parameter in the historical data.

Thereafter, the instructions 1112 cause the processing resource 1104 to extract, from amongst the plurality of operating parameters, a subset of operating parameters that are non-colinear. The operating parameters that are colinear vary in sync with each other. Thus, when a given operating parameter is exhibiting values lying in the expected range, other operating parameters that are colinear to the given operating parameter may also be within their respective expected ranges. One or more of the operating parameters that are colinear may be identified by analyzing the historical data. To elaborate, referring to the above example of the fluid control system, the flow rate of the valve and rate of change of fluid level in the tank are colinear operating parameters since the rate of change of fluid level is directly proportional to the flow rate at which the valve discharges fluid out of the tank.

The instructions 1112 cause the processing resource 1104 to identify a duration of time within the time period where each operating parameter in the subset of operating parameters has values within the identified corresponding expected range of values. In other words, the instructions 1112 cause the processing resource 1104 to identify a duration of time where the non-colinear operating parameters have values within their expected ranges. As apparent from the previous description, the identified duration of time corresponds to a time window in the time period where non-colinear operating parameters of the industrial process are in their steady state. The operating parameters excluded from the subset of operating parameters, by the virtue of their collinearity with the operating parameters in the subset of parameter, may also be considered to be in their steady state.

In another example, the instructions 1112 cause the processing resource 1104 to identify the duration of time within the time period based on transient values of the operating parameters in the subset of operating parameters. The transient value of an operating parameter is indicative of a change in values of the operating parameter from the expected range of values corresponding to a mode of operation, from amongst the at least one mode of operation of the industrial process, to another.

Once the duration of time where the non-colinear operating parameters have values within their expected ranges, is identified, the instructions 1112 cause the processing resource 1104 to select the historical data corresponding to the identified duration of time as data to train an AI model to monitor operation of the system.

As the historical data corresponding to the identified duration of time pertains to the time window in the time period when the industrial process exhibits a normal operation behavior, it may be most appropriate portion of the historical data that may be used for the training of the AI model.

Thus, the methods and systems of the present subject matter provide for selection of training data to train an AI model to monitor an industrial process. Although implementations of selection of the training data have been described in a language specific to structural features and/or methods, it is to be understood that the appended claims are not necessarily limited to the specific features or methods described. Rather, the specific features and methods are disclosed as example implementations for selection of training data that may train AI models to monitor industrial processes.

1. A method comprising:
obtaining time series data corresponding to a plurality of operating parameters of an industrial process, the time series data comprising values of each of the plurality of operating parameters recorded over a time period;
for each of the plurality of operating parameters, estimating a range of values corresponding to at least one mode of operation of the industrial process when the industrial process is exhibiting a normal operation behavior;
identifying one or more steady time windows for each of the plurality of operating parameters, a steady time window of an operating parameter being a duration of time within the time period where values of the operating parameter are within the estimated range of values;
determining at least one composite steady time window, wherein the at least one composite steady time window is a duration of time within the time period where a steady time window of a maximum of the operating parameters, from amongst the plurality of operating parameters, overlap; and
providing the time series data of the plurality of operating parameters, corresponding to the composite steady time window, as training data to an Artificial Intelligence AI model to be trained to monitor normal operation behavior of the industrial process.

2. The method as claimed in claim 1, wherein the estimating the range of values for an operating parameter, corresponding to the at least one mode of operation of the industrial process comprises:
identifying, by applying a probability density function on the time series data of the operating parameter, one or more set of reoccurring values in the time series data, each of the one or more set of reoccurring values being represented as a peak in an output of the probability density function, each peak representing a mode of operation; and
estimating the range of values for each of the at least one mode of operation based on the peak of the respective mode of operation.

3. The method as claimed in claim 2, wherein the probability density function is kernel density estimation.

4. The method as claimed in claim 1, wherein the at least one composite steady time window comprises a longest duration of time within the time period where the steady time window of the maximum of the operating parameters, from amongst the plurality of operating parameters, overlap.

5. The method as claimed in claim 4, wherein determining the at least one composite steady time window comprises identifying transient values of the plurality of the operating parameters, a transient value of an operating parameter being indicative of a change in values of the operating parameter from the range of values corresponding to a mode of operation, from amongst the at least one mode of operation of the industrial process, to another.

6. The method as claimed in claim 1, wherein the method comprises:
scaling the values of each of the plurality of operating parameters based on the estimated range of values of the respective parameter.

7. The method as claimed in claim 1, wherein the method comprises filtering anomalous data from the time series data.

8. The method as claimed in claim 1, wherein the method comprising computing missing data in the time series data.

9. A system comprising:
a processor;
a steady state range determination module coupled to the processor to:
for a time series data corresponding to a plurality of operating parameters of an industrial process recorded over a time period, estimate a range of values for each of the plurality of operating parameters corresponding to at least one mode of operation of the industrial process when the industrial process is exhibiting a normal operation behavior;
a batch processing module coupled to the processor:
divide, into plurality of batches the time series data, each batch comprising the time series data corresponding to a time frame of predetermined duration in the time period;
compute a first score for the respective batches based on a number of operating parameters, from amongst the plurality of operating parameters, having values within the corresponding estimated range of values;
compute a second score for the respective batches based on a number of transient values of plurality of the operating parameters in the corresponding time series data, a transient value of an operating parameter being indicative of a change in values of the operating parameter from the ranges corresponding to one mode of operation of the industrial process to the ranges corresponding to another mode of operation of the industrial process;
assign a composite score to the respective batches as a weighted sum of the first score and the second score;
a training period selection module coupled to the processor, to:
identify, based on the composite score, a set of consecutive batches in the plurality of batches;
provide the time series data of the plurality of operating parameters, corresponding to the identified set of consecutive batches, as training data to an AI model to be trained to monitor normal operation behavior of the industrial process.

10. The system as claimed in claim 9, wherein the system comprises a preprocessing module to filter the anomalous data from the time series data.

11. The system as claimed in claim 10, wherein the preprocessing module is to compute data missing in the time series data.

12. The system as claimed in claim 11, wherein the preprocessing module is to extract, from amongst the plurality of operating parameters, a subset of operating parameters that are non-colinear.

13. The system as claimed in claim 12, wherein the steady state range determination module is to estimate the range of values corresponding to at least one mode of operation of the industrial process based on the subset of operating parameters.

14. The system as claimed in claim 9, wherein the batch processing module is to scale the values of each of the plurality of operating parameters for the respective batches based on the steady state range of values of the respective parameter.

15. A non-transitory computer-readable medium comprising instructions executable by a processing resource to:
identify, based on historical data corresponding to operation of a system over a time period, an expected range of values for each of a plurality of operating parameters associated with the system;
extract, from amongst the plurality of operating parameters, a subset of operating parameters that are non-colinear;
identify a duration of time within the time period where each operating parameter in the subset of operating parameters has values within the identified corresponding expected range of values; and
select the historical data corresponding to the identified duration of time as data to train an AI model to monitor operation of the system.

16. The non-transitory computer-readable medium as claimed in claim 15, wherein the computer-readable instructions are executable by the processing resource to:
identify, based on the historical data, the expected range of values for each of the plurality of operating parameters associated with the system for at least one mode of operation of the system.

17. The non-transitory computer-readable medium as claimed in claim 16, wherein the computer-readable instructions are executable by the processing resource to:
identify the duration of time within the time period based on transient values of the operating parameters in the subset of operating parameters, a transient value of an operating parameter being indicative of a change in values of the operating parameter from the expected range of values corresponding to a mode of operation, from amongst the at least one mode of operation of the industrial process, to another.

18. The non-transitory computer-readable medium as claimed in claim 15 further comprising instructions executable by the processing resource to filter anomalous data from the historical data.

19. The non-transitory computer-readable medium as claimed in claim 16 further comprising instructions executable by the processing resource to compute data missing in the historical data.

20. The non-transitory computer-readable medium as claimed in claim 16 further comprising instructions executable by the processing resource to scale values of each of the plurality of operating parameters in the historical data based on the identified expected range of values of the respective parameter.
